(19) United States
(12) Patent Application Publication
(10) Pub. No.: US 2010/0255917 A1
(43) Pub. Date: Oct. 7, 2010

(54) GAME SYSTEM, GAME APPARATUS, GAME SERVER, AND RECORDING MEDIUM RECORDED WITH A PROGRAM FOR GAMES

(75) Inventors: Jun Nemoto, Tokyo (JP); Shintaro Osato, Tokyo (JP); Hiroyuki Ashida, Tokyo (JP)

Correspondence Address: RANKIN, HILL & CLARK LLP, 38210 GLENN AVENUE, WILLOUGHBY, OH, 44094-7808, US

(73) Assignee: KONAMI DIGITAL ENTERTAINMENT CO., LTD., Tokyo (JP)

(21) Appl. No.: 12/751,431

(22) Filed: Mar. 31, 2010

(30) Foreign Application Priority Data
Mar. 31, 2009 (JP) 2009-088549

(51) Int. Cl. A63F 13/00

(52) U.S. Cl. 463/42; 463/43

(57) ABSTRACT

In a game system which may keep players interested in two or more games for a long time, a first game control server stores game result data transmitted from a first game device in a first data storing section. Then, the first game control server generates first usable data based on the newly stored game result data, and stores the first usable data in a data storing means of a first usable data transmitting section in which the first usable data are ready for transmission. Upon receipt of a transmission request command from a second game control server, the first game control server transmits the first usable data to the second game control server. Each player may execute a game program using the data obtained from a previously executed game and other usable data transmitted from a different game device.

### TECHNICAL FIELD

The present invention relates to a game system, a game device, a game server, and a recording medium recorded with a game program, all of which are intended to allow a player to obtain game result information on a game played by the player in one game device with one game program stored therein and to use the game result information in another game played by the player in another game device with another game program stored therein.

### BACKGROUND ART

Japanese Patent No. 3715302 discloses a game server system that enables game elements to be edited using different terminals and stores game results for each player.

Japanese Patent No. 3683848 discloses a game system in which personal information and game result data for a plurality of players are stored in a center server and are provided to shop servers and home-use game devices via the Internet and also to mobile game terminals via a communication network so that a game may be played in any of terminals connected to the shop servers, home-use game devices, and mobile game terminals.

In the game system of Japanese Patent No. 3683848, games the same sort can be executed in different terminals and the players may be kept interested in the games of the same sort. However, if there are different sorts of games are available, the players' interests may change from one sort to another and it is hard to keep the players interested in the games of the same sort.

Accordingly, an object of the present invention is to provide a game system, a game device, a game server, and a recording medium recorded with a game program, all of which are intended to keep the players' interests in the games for a long time.

### SUMMARY OF INVENTION

In a first embodiment of the present invention, a game system may comprise a first game control server and at least one second game control server capable of intercommunicating with the first game control server. The first game control server comprises a first data storing section for storing player information on each of a plurality of players operating first game devices for executing a first game program. For example, the player information includes at least game result data for each player. The at least one second game control server is capable of intercommunicating with the first game control server and comprises a second data storing section for storing player information on each of a plurality of players operating second game devices for executing a second game program. Here again, the player information includes at least game result data on each player.

The first game control server also comprises a first usable data transmitting section for transmitting first usable data to the second game control server in response to a transmission request command from the second game control server. The first usable data for each of the players are included in the game result data for the player, which are stored in the first data storing section, and are usable by the player when the second game program is executed by the player in the second game device. The second game control server also comprises a second usable data transmitting section for transmitting second usable data to the first game control server in response to a transmission request command from the first game control server. The second usable data for each of the players are included in the game result data for the player, which are stored in the second data storing section, and are usable by the player when the first game program is executed by the player in the first game device. The first game control server further comprises a first usable data storing section for storing the second usable data for each of the players transmitted from the second game control server. The second game control server further comprises a second usable data storing section for storing the first usable data for each of the players transmitted from the first game control server.

The first game program is configured to allow each of the players operating the first game devices to proceed with the game using the data for the player stored in the first data storing section and the data for the player stored in the first usable data storing section. The second game program is configured to allow each of the players operating the second game devices to proceed with the game using the data for the player stored in the second data storing section and the data for the player stored in the second usable data storing section.

In the game system of the present invention, a player obtains a given game result by operating the first game device to execute the first game program using data acquired from the first game control server. Then, when the player operates the second game device to execute the second game program using data acquired from the second game control sever, the player may use in the second game device the first usable data based on the game result obtained by executing the first game program. Likewise, when the player operates the first game device to execute the first game program using data acquired from the first game control sever, the player may use in the first game device the second usable data based on the game result obtained by executing the second game program. As a result, the player may reflect the game result, which the player has obtained from one sort of game, in another sort of game. Thus, the game system of the present invention may keep the player interested in both of the two games.

An idea to have the game result obtained from one sort of game reflected in another sort of game may apply to various situations: there are one first game control server and one second game control server; one first game control server and two or more second game control servers; and two or more first game control servers and two or more second game control servers. The number of the game control servers may increase. For clarity of understanding, the foregoing description may apply to two of the game control servers among the game control servers, namely, one first game control server and one second game control server. However, the present invention is not limited to the situation where there are only two game control servers.

The first usable data transmitting section may be configured to transmit data updated from the previously transmitted first usable data as the first usable data for each of the players to be next transmitted without transmitting unupdated data. The second usable data transmitting section may be configured to transmit data updated from the previously transmitted second usable data as the second usable data for each of the players to be next transmitted without transmitting unupdated data. In this manner, if only a difference between current and previous data, namely, data updated from the data previously transmitted are transmitted as usable data, the amount of data to be transmitted between the first and second game control servers may significantly be reduced, thereby alleviating the workload of the game control servers.

The first data storing section of the first game control server may store at least game result data for a plurality of players transmitted from at least one first game server to which a plurality of first game devices are connected. In this configuration, the first game control server may be called as a center server. Likewise, the second data storing section of the second game control server may store at least game result data for a plurality of players transmitted from at least one second game server to which a plurality of second game devices are connected.

In a second embodiment of the present invention, a game system may be configured to include only one game server which works as both the first and second game control servers. In this configuration, the game server includes a first data storing section, a second data storing section, a first usable data providing section, and a second usable data providing section. The first data storing section stores at least game result data for each of the players operating the first game devices for executing a first game program. The second data storing section stores at least game result data for each of the players operating the second game devices for executing a second game program. The first usable data providing section provides the second game devices with first usable data for each of the players that are included in the game result data for the player, which are stored in the first data storing section, and that are usable by the player when the second game program is executed by the player in the second game device. The second usable data providing section provides the first game devices with second usable data for each of the players that are included in the game result data for the player, which are stored in the second data storing section, and that are usable by the player when the first game program is executed by the player in the first game device. Also in the second embodiment, the first game program is configured to allow each of the players operating the first game devices to proceed with the game using the game result data for the player stored in the first data storing section and the second usable data for the player provided by the second usable data providing section. The second game program is configured to allow each of the players operating the second game devices to proceed with the game using the game result data for the player stored in the second data storing section and the first usable data for the player provided by the first usable data providing section. According to the second embodiment, the game system may be implemented using one server.

The present invention may be implemented as a game device that proceeds with a game using game result data obtained by a player from a previously executed game. In one or more embodiments, the game device may comprise a data receiving section, a game executing section, a game result data storing section, and a data transmitting section. The data receiving section receives at least game result data previously obtained and other usable data from a game control server to which the game device is connected via a communication network. The game executing section proceeds with the game using game result data obtained by a player from a previously executed game and other usable data. The game result data storing section stores game result data newly generated as a result of the game executed by the game executing section. The data transmitting section transmits the game result data newly generated and stored in the game result data storing section to the game control server via the communication network upon completion of the game. In the game device of the present invention, the usable data are at least a part of game result data obtained by the player as a result of a different sort of game executed by the player in a different game device. In the game device of the present invention, each player may proceed with the game by using at least a part of the game result data obtained by the player as a result of a different sort of game executed by the player in a different game device. Thus, the player may be kept interested in both of the two games for a long time.

Preferably, the game device may further comprise a new usable data notifying section for notifying the player of new usable data which have newly been obtained and included in the other usable data, but were not present in the other usable data when the game was previously executed. The player may strategically proceed with the game since the presence of new usable data that the player may use is notified to the player by the new usable data notifying section.

Game programs used in the first and second game devices each implement the aforementioned data receiving section, game executing section, game result data storing section, and data transmitting section in the computers of the first and second game devices.

### BRIEF DESCRIPTION OF DRAWINGS

FIG. 1 illustrates the configuration of a game system using two game control servers according to a first embodiment of the present invention.

FIG. 2 is an example display on a screen of a first game device, indicating that new usable data, in this case, a new usable item has been added.

FIG. 3 is an execution timing chart of the game program in the game system of FIG. 1.

FIGS. 4A and 4B each illustrate an example combination of game control servers available for the game system of the present invention.

FIG. 5 illustrates the configuration of a game system using one game server according to a second embodiment of the present invention.

### DESCRIPTION OF EMBODIMENTS

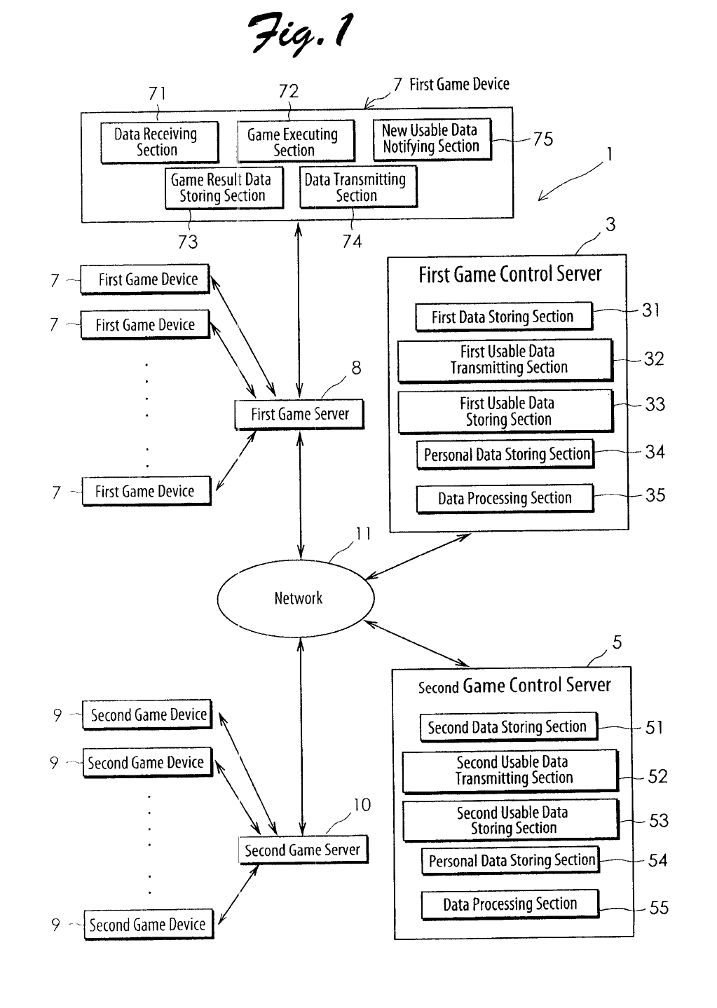

Now, embodiments of a game system according to the present invention will be described in detail with reference to the drawings. FIG. 1 illustrates the configuration of a game system using two game control servers according to a first embodiment of the present invention. An example configuration of a game device is illustrated in FIG. 1 wherein functions of the game device 7 are implemented. A second game device 9 is configured in the same manner as the first game device 7.

The game system of FIG. 1 comprises a first game control server 3 and a second game control server 5 that are capable of intercommunicating with each other. The first game control server 3 includes a first data storing section 31, a first usable data transmitting section 32, a first usable data storing section 33, a personal data storing section 34, and a data processing section 35. The personal data storing section 34 stores data that identify a plurality of players, including IDs of the players. The data processing section 35 is constituted from a CPU and is in charge of processing all the data in the first game control server 3. The first data storing section 31 stores player information on each of the players, including at least game result data for each of the players who operate the first game devices 7 for executing a first game program. In other words, the first data storing section 31 stores player information on each of the players including game result data for each player together with an identification number such as an ID of each player. The game result data may be either a time-series collection of data regarding game results obtained by each player in the past or game result data regarding the game currently executed by each player. The first usable data transmitting section 32 transmits first usable data to the second game control server 5 in response to a transmission request command from the second game control server 5. The first usable data are included in the player information on each of the players including the game result data for each player stored in the first data storing section 31, and are usable by each player when the second game program is executed by the player in the second game device 9. In the configuration according to the first embodiment, the first usable data transmitting section 32 includes a data storing means for storing first usable data in advance. The first usable data refer to data that are apart of the game result data for each player, which are stored in the first data storing section 31, and that are used by the second game program installed in the second game device 9 under the control of the second game control server 5. The first usable data transmitting section 32 of the first embodiment stores in the aforementioned data storing means data updated from the previously transmitted first usable data for each of the players as the first usable data for each player to be next transmitted. The first usable data transmitting section 32 is configured to transmit a difference between the current first usable data and the previously transmitted first usable data.

The first usable data storing section 33 stores second usable data transmitted from the second game control server. The second usable data refer to data transmitted from a second usable data transmitting section 52 of the second game control server 5. As with the first usable data, the second usable data are a part of the game result data for each player, which are stored in the second data storing section 51 of the second game control server 5, and are used by the first game program installed in the first game device 7 under the control of the first game control server 3. Since the second usable data are stored in the first usable data storing section 33, the first game device 7 will normally work using the second usable data stored in the first usable data storing section 33 as long as the first game control server 3 works properly even if the second game control server 5 breaks down. In other words, the first usable data storing section 33 is provided for the purpose of mirroring of a part of the data stored in the second game control server 5.

The second game control server 5 includes a second data storing section 51, a second usable data transmitting section 52, a second usable data storing section 53, a personal data storing section 54, and a data processing section 55. The personal data storing section 54 stores data that identify a plurality of players, including IDs of the players. The data processing section 55 is constituted from a CPU and is in charge of processing all the data in the second game control server 5. The second data storing section 51 stores at least game result data for each of the players operating the second game devices 9 for executing a second game program. In other words, the second data storing section 51 stores game result data for each player together with an identification number such as an ID of each player. The second usable data transmitting section 52 transmits the second usable data to the first game control server 3 in response to a transmission request command from the first game control server 3. The second usable data are included in the player information on each of the players including the game result data for each player, which are stored in the second data storing section 51, and are usable by each player when the first game program is executed by the player in the first game device 7. The transmission request command is transmitted from the data processing section 55 to the first game control sever 3 according to predetermined timing. Also, the transmission request command is transmitted from the data processing section 35 to the second game control server 5 according to predetermined timing. In the configuration according to the first embodiment, the second usable data transmitting section 52 includes a data storing means for storing second usable data in advance. The second usable data refer to data that are a part of the game result data for each player, which are stored in the second data storing section 51, and that are used by the first game program installed in the first game device 7 under the control of the first game control server 3. The second usable data transmitting section 52 of the first embodiment stores in the aforementioned data storing means data updated from the previously transmitted second usable data for each of the players as the second usable data for each player to be next transmitted.

The second usable data storing section 53 stores first usable data transmitted from the first game control server. The first usable data refer to data transmitted from the first usable data transmitting section 32 of the first game control server 3. The first usable data are a part of the game result data for each player, which are stored in a first data storing section 31 of the first game control server 3, and are used by the second game program installed in the second game device 9 under the control of the second game control server 5. The second usable data storing section 53 is provided for the purpose of mirroring of a part of the data stored in the first game control server 3.

The first game program executed in the game device 7 is configured to allow each of the players operating the first game devices 7 to proceed with the game using the data for the player stored in the first data storing section 31 and the data for the player stored in the first usable data storing section 33. Also, the second game program is configured to allow each of the players operating the second game devices 9 to proceed with the game using the data for the player stored in the second data storing section 51 and the data for the player stored in the second usable data storing section 53.

In the configuration of the first embodiment, a plurality of first game devices 7 are connected to one first game server 8. For example, the first game server 8 is installed in a shop together with the first game devices 7. The first game server 8 has a function of providing the game result data generated in the first game devices 7 to the first game control server 3 disposed in a different location from the first game server 8 via a communication network 11 such as the Internet. The first game server 8 also has a function of providing data required for the game and obtained from the first game control server 3 to the first game devices 7 via the communication network 11. In the configuration of the first embodiment, only one first game server 8 is illustrated, but a plurality of first game servers 8 are connected to the first game control server 3 via the communication network 11. Further, a plurality of second game devices 9 are connected to one second game server 10. Here again, for example, the second game server 10 is installed in a shop together with the second game devices 9. The second game server 10 has a function of providing the game result data generated in the second game devices 9 to the second game control server 5 disposed in a different location from the second game server 10 via the communication network 11 such as the Internet. The second game server 10 also has a function of providing data required for the game and obtained from the second game control server 5 to the second game devices 9 via the communication network 11. In the configuration of the first embodiment, only one second game server 10 is illustrated, but a plurality of second game servers 10 are connected to the second game control server 5 via the communication network 11.

The first game devices 7 each include a data receiving section 71, a game executing section 72, a game result data storing section 73, a data transmitting section 74, and a new usable data notifying section 75. The data receiving section 71 acquires or receives at least the game result data previously obtained and other usable data, namely, the second usable data, from the first data storing section 31 and the first usable data storing section 33 of the first game control server 3 via the first game server 8 to which the first game device 7 is connected. The game executing section 72 proceeds with the game using the game result data previously obtained and other usable data, namely, the second usable data. The game result data storing section 73 stores game result data newly generated as a result of the game executed by the game executing section 72. The data transmitting section 74 transmits the game result data newly generated and stored in the game result data storing section 73 to the first data storing section 31 of the first game control server 3 via the first game server 8 and the communication network 11 upon completion of the game. In the first game devices 7, the second usable data are at least a part of game result data obtained by the player as a result of a game that is different from the game executed by the player in the game device 7 and has been executed by the player in a different game device 9. It is arbitrary how to use the second usable data in the first game devices 7. For example, if the first game program is a medal game played by entering medals, the acquired second usable data may be used as an item for temporarily increasing the rate of letting out medals. If the first game program is intended for two players, the acquired second usable data may be used as an item for getting a new weapon. Thus, if the player is allowed to proceed with the game in the first game device 7 by using at least a part of the game result data obtained by the same player from a different game, the player may be kept interested in both of the game executed in the first game device 7 and the game executed in the second game device 9 for a long time.

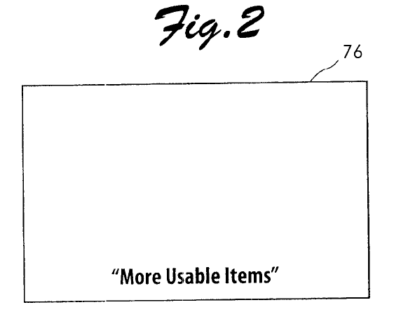

The new usable data notifying section 75 notifies the player of new usable data which have newly been obtained and included in the other usable data, but were not present in the other usable data when the game was previously executed. FIG. 2 is an example display on a screen 76 of a first game device, indicating that new usable data, in this case, a new usable item has been added with the wording of “More Usable Items”. It is arbitrary how to represent the notification. Thus, the player may strategically proceed with the game since the presence of new usable data is notified to the player by the new usable data notifying section 75.

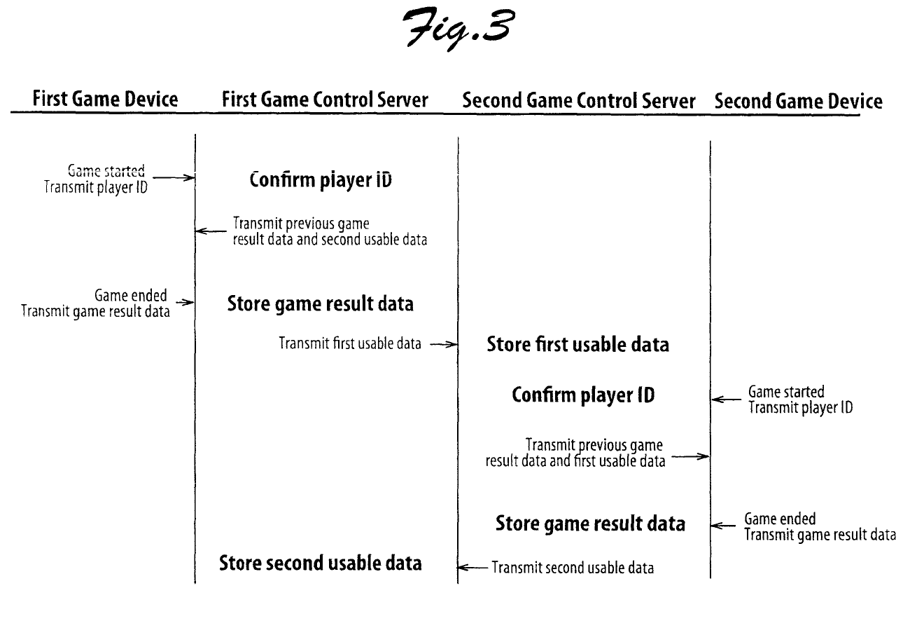

FIG. 3 shows a flow of game proceeding wherein one player executes the first game program in the first game device 7 and subsequently executes the second game program in the second game device 9 on an assumption that the first game devices 7 are connected to the first game control sever 3 via the communication network 11 and the second game devices 9 are connected to the second game control server 5 via the communication network 11. The first and second game servers 8, 10 of FIG. 1 are omitted from FIG. 3. First, the player transmits his/her ID or password for identifying the player from the first game device 7 to the first game control server 3 in order to start a game in the first game device 7. The first game control server 3 confirms the player's ID and then transmits the game result data previously obtained and stored for the player and the second usable data for the player to the first game device 7. The player enjoys the game by executing the first game program using the previously obtained game result data and the second usable data. Once the player has operated the game device to end the game, the game result data are transmitted from the first game device 7 to the first game control server 3. Depending upon how the first game program is configured, data may be transferred between the first game device 7 and the game control server 3 during a period from the start to the end of the game. For example, if player ranking information is displayed on a screen of the first game device 7, data are transferred between the first game device 7 and the first game control server 3 in the course of the game.

The first game control server 3 stores the game result data in the first data storing section 31 upon receipt of the data transmitted from the first game devices 7. Then, the first game control server 3 generates first usable data based on the game result data newly obtained and stores the generated first usable data in the data storing means in the first usable data transmitting section 32 such that the first usable data are ready for transmission. In response to a transmission request command from the second game control server 5, the first game control server 3 transmits the first usable data to the second game control server 5. In other words, the second game control server 5 reads out the first usable data stored in the first game control server 3, and stores the data in second usable data storing section 53 in the second game control server 5. The transmission request (to read the data) is periodically transmitted depending upon operating conditions in the second game control server 5. At these times, the first usable data for other players are also transmitted to the second game control server 5 together with the data for the player concerned.

Next, the player transmits his/her ID or password for identifying the player from the second game device 9 to the second game control server 5 in order to start a game in the came device 9. The second game control server 5 confirms the player's ID and then transmits to the second game device 9 the game result data previously obtained and stored for the player and the first usable data for the player. Once the player has operated the game device to end the game, the game result data are transmitted from the second game device 9 to the second game control server 5. The second game control server 5 stores the game result data in the second data storing section 51 upon receipt of the data transmitted from the second game devices 9. Then, the second game control server 5 generates second usable data based on the game result data newly obtained and stores the generated second usable data in the data storing means in the second usable data transmitting section 52 such that the second usable data are ready for transmission. In response to a transmission request command from the first game control server 3, the second game control server 5 transmits the second usable data to the first game control server 3. In other words, the first game control server 3 reads out the second usable data stored in the second game control server 5, and stores the data in the first usable data storing section 33 in the first game control server 3. The transmission request (to read the data) is periodically transmitted depending upon operating conditions in the first game control server 3. At these times, the second usable data for other players are also transmitted to the first game control server 3 together with the data for the player concerned. The aforementioned steps are subsequently repeated.

In the game system according to the first embodiment, the player obtains certain game result data by acquiring data from the first game control server 3 and operating the first game device 7 for executing the first game program; and then the player is allowed to acquire from the second game control server 5 first usable data based on the game result data obtained by executing the first game program and to use the first usable data in the second game device 9 for executing the second game program. The opposite is true, namely, the player is allowed to acquire from the first game control server 3 second usable data based on the game result data obtained by executing the second game program and to use the second usable data in the first game device 7 for executing the first game program. As a result, the player may wish to reflect in a game running on a game device or the first game device 7 the game result data obtained by the same player by executing a different game in a different game device or the second game device 9. Thus, the player may be kept interested in both of the two games for a long time.

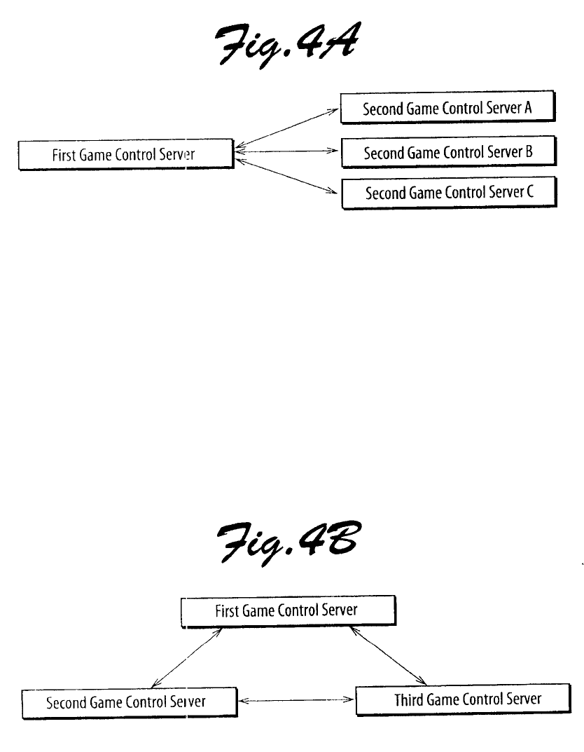

An idea to have the game result obtained from one sort of game reflected or used in another sort of game may apply to various situations: there are one game control server and another game control server; one game control server and two or more other game control servers; and two or more game control servers and two or more other game control servers. FIG. 4A illustrates a situation where one first game control server is capable of intercommunicating with three second game control servers A to C. In this situation, the first control game server stores in the first data storing section three sorts of second usable data transmitted or read out from the three second game control servers A to C. The three second game control servers A to C each store the first usable data transmitted or read out from the first game control server in the second usable data storing sections thereof. FIG. 4B illustrates a situation where three game control servers, a first, a second, and a third game control servers are capable of intercommunicating with one another. In this situation, the first game control server stores usable data transmitted or read out from the second and third game control servers; the second game control server stores usable data transmitted or read out from the first and third game control servers; and the third game control server stores usable data transmitted or read out from the first and second game control servers. In these manners, the player may be kept interested in games of multiple sorts.

The game programs installed in the computers of the first and second game devices are recorded in a computer-readable recording medium. Each game program implements the aforementioned data receiving section 71, game executing section 72, game result data storing section 73, data transmitting section 74, and new usable data notifying section 75 in the computer.

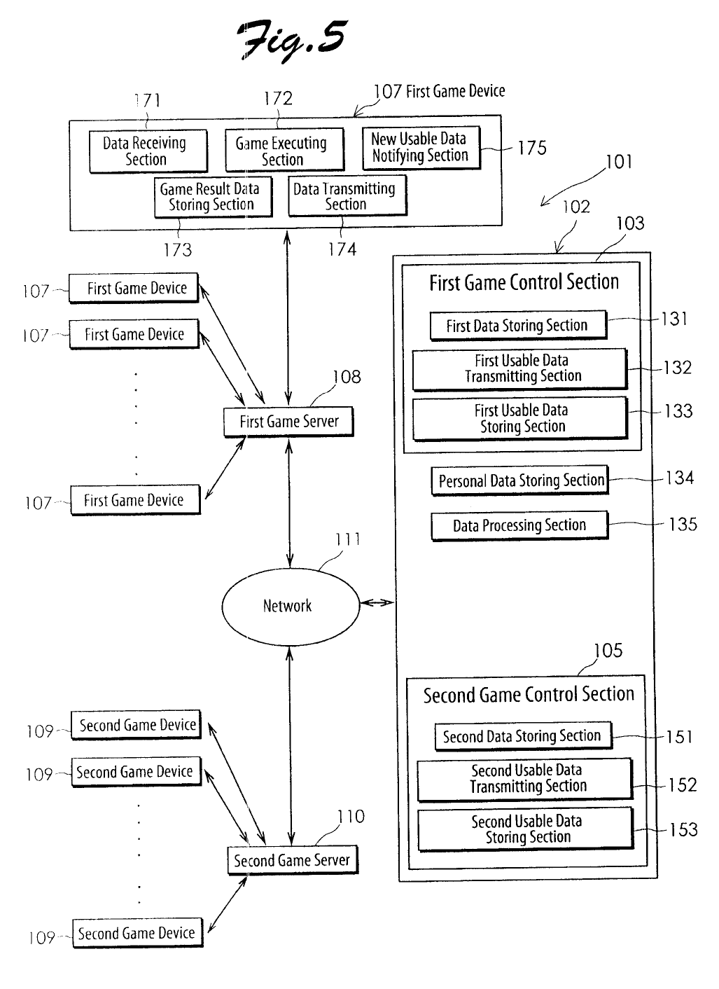

FIG. 5 illustrates the configuration of a game system using one game server according to a second embodiment of the present invention. The parts of the game system of FIG. 5 are allocated reference numerals obtained by adding 100 to those of the corresponding parts of the game system of FIG. 1 according to the first embodiment. In the game system of the second embodiment, a game server 102 comprises a first game control section 103 and a second game control section 105 that respectively implement the functions of the first game control server 3 and the second game control server 5 of the game system of FIG. 1 according to the first embodiment. The game server 102 also comprises a personal data storing section 134 and a data processing section 135 that are commonly used by the first and second game control sections 103,105. The personal data storing section 134 stores data for identifying a plurality of players including IDs of the players. The data processing section 135 is constituted from a CPU and is in charge of processing all the data in the first and second control sections 103,105.

The first control section 103 includes a first data storing section 131, a first usable data providing section 132, and a first usable data storing section 133. The first data storing section 131 stores player information on each of the players, including at least game result data for each player, operating the first game devices 107 for executing a first game program. In other words, the first data storing section 131 stores player information including the game result data for each player and an identification number of each player such as an ID. The game result data may be a time-series collection of data regarding game results obtained by each player in the past or game result data regarding the game currently executed by each player. The first usable data providing section 132 provides the first usable data to the second game control section 105 in response to a request command from the second game control section 105. The first usable data are included in the game result data for each of the players, which are stored in the first data storing section 131, and are usable by each player when the second game program is executed by the player in the second game device 109 under the control of the second game control section 105. In the configuration according to the second embodiment, the first usable data providing section 132 includes a data storing means for storing the first usable data in advance. The first usable data refer to data that are a part of the game result data for each player, which are stored in the first data storing section 131, and are used by the second game program installed in the second game device 109 under the control of the second game control section 105. The first usable data providing section 132 of the second embodiment stores in the aforementioned data storing means data updated from the previously provided first usable data for each of the players as the first usable data for each player to be next provided. In other words, the first usable data providing section 132 is configured to provide a difference between the current first usable data and the previously provided first usable data.

The first usable data storing section 133 stores second usable data for each of the players. As with the first usable data, the second usable data refer to data provided by a second usable data providing section 152 of the second game control section 105. The second usable data are a part of the game result data for each of the players, which are stored in a second data storing section 151 of the second game control section 105, and are used by the first game program installed in the first game device 107 under the control of the first game control section 103.

The second game control section 105 includes the second data storing section 151, the second usable data providing section 152, and a second usable data storing section 153. The second data storing section 151 stores at least game result data for each of the players operating the second game devices 109. In other words, the second data storing section 151 stores the game result data for each player and an identification number of each player such as an ID. The second usable data providing section 152 provides the second usable data to the first game control section 103 in response to a request command from the first game control section 103. The second usable data are included in the player information on each of the players including the game result data for each player, which are stored in the second data storing section 151, and are usable by each player when the first game program is executed by the player in the first game device 107 under the control of the first game control section 103. The request command is given from the data processing section 155 to the first game control section 103 according to predetermined timing. Also, the request command is given from the data processing section 135 to the second game control section 105 according to predetermined timing. In the configuration according to the second embodiment, the second usable data providing section 152 includes a data storing means for storing the second usable data in advance. The second usable data refer to data that are a part of the game result data for each player, which are stored in the second data storing section 151, and are used by the first game program installed in the first game device 107 under the control of the first game control section 103. The second usable data providing section 152 of the second embodiment stores in the aforementioned data storing means data updated from the previously provided second usable data for each of the players as the second usable data for each player to be next provided.

The second usable data storing section 153 stores first usable data for each of the players. The first usable data refer to data provided by the first usable data providing section 132 of the first game control section 103. The first usable data are a part of the game result data for each of the players, which are stored in the first data storing section 131 of the first game control section 103, and are used by the second game program installed in the second game device 109 under the control of the second game control section 105.

Also in the second embodiment, the first game program is configured to allow each of the players operating the first game devices to proceed with the game using the game result data for the player stored in the first data storing section and the second usable data for the player provided by the second usable data providing section. The second game program is configured to allow each of the players operating the second game devices to proceed with the game using the game result data for the player stored in the second data storing section and the first usable data for the player provided by the first usable data providing section.

According to the present invention, the game result obtained from one sort of game may be reflected in another sort of game. Therefore, the players may be kept interested in both of the two games for a long time.

The present invention is not limited to the example embodiments described above, and various modifications and variations of the example embodiments and other embodiments of the present invention are deemed to lie within the spirit and scope of the present invention.

1. A game system comprising:
a plurality of first game devices for executing a first game program, each operated by a plurality of players;
a plurality of second game devices for executing a second game program, each operated by a plurality of players;
a first game control server; and
at least one second game control server capable of intercommunicating with the first game control server,
the first game control server including:
a first data storing section for storing at least game result data for each of the players operating the first game devices;
a first usable data transmitting section for transmitting first usable data to the at least one second game control server in response to a transmission request command from the at least one second game control server, the first usable data being included in the game result data for each of the players, which are stored in the first data storing section, and being usable by each of the players when the second game program is executed by the player in the second game device; and
a first usable data storing section for storing second usable data transmitted from the at least one second game control server; and
the at least one second game control server including:
a second data storing section for storing at least game result data for each of the players operating the second game devices;
a second usable data transmitting section for transmitting the second usable data to the first game control server in response to a transmission request command from the first game control server, the second usable data being included in the game result data for each of the players, which are stored in the second data storing section, and being usable by each of the players when the first game program is executed by the player in the first game device; and
a second usable data storing section for storing the first usable data transmitted from the first game control server,
wherein the first game program is configured to allow each of the players operating the first game devices to proceed with the game using the data for the player stored in the first data storing section and the data for the player stored in the first usable data storing section; and
wherein the second game program is configured to allow each of the players operating the second game devices to proceed with the game using the data for the player stored in the second data storing section and the data for the player stored in the second usable data storing section.

2. The game system according to claim 1, wherein the at least one second game control server includes a plurality of second game control servers, and the second game control servers are capable of intercommunicating with the first game control server.

3. The game system according to claim 1, wherein:
the first usable data transmitting section is configured to transmit data updated from the previously transmitted first usable data as the first usable data for each of the players to be next transmitted; and
the second usable data transmitting section is configured to transmit data updated from the previously transmitted second usable data as the second usable data for each of the players to be next transmitted.

4. The game system according to claim 1, further comprising at least one first game server and at least one second game server, wherein:
the first game devices are connected to the at least one first game server and the first game control server stores in the first data storing section at least the game result data for each of the players transmitted from the at least one first game server; and
the second game devices are connected to the at least one second game server and the at least one second game control server stores in the second data storing section at least the game result data for each of the players transmitted from the at least one second game server.

5. A game device that proceeds with a game using game result data obtained by a player from a previously executed game, comprising:
a data receiving section for receiving at least the game result data previously obtained and other usable data from a game control server to which the game device is connected via a communication network, wherein the usable data are at least a part of game result data obtained by the player as a result of a different sort of game executed by the player in a different game device;
a game executing section for executing the game using the game result data and other usable data;
a game result data storing section for storing game result data newly generated as a result of the game executed by the game executing section; and
a data transmitting section for transmitting the game result data newly generated and stored in the game result data storing section to the game control server via the communication network upon completion of the game.

6. The game device according to claim 5, further comprising a new usable data notifying section for notifying the player of new usable data which have newly been obtained and included in the other usable data, but were not present in the other usable data when the game was previously executed.

7. A computer-readable recording medium recorded with a game program to be used in a computer of a game device to proceed with a game using game result data obtained by a player from a previously executed game, the game program implementing in the computer of the game device:
a data receiving section for receiving at least the game result data obtained from the previously executed game and other usable data from a game control server to which the game device is connected via a communication network, wherein the usable data are at least a part of game result data obtained by the player as a result of a different sort of game executed by the player in a different game device;
a game executing section for executing the game using the game result data and other usable data;
a game result data storing section for storing game result data newly generated as a result of the game executed by the game executing section;
a data transmitting section for transmitting the game result data newly generated and stored in the game result data storing section to the game control server via the communication network upon completion of the game; and
a new usable data notifying section for notifying the player of new usable data which have newly been obtained and included in the other usable data, but were not present in the other usable data when the game was previously executed.

8. A game system comprising:
a plurality of first game devices for executing a first game program, each operated by a plurality of players;
a plurality of second game devices for executing a second game program, each operated by a plurality of players; and
a game server including:
a first data storing section for storing at least game result data for each of the players operating the first game devices;
a second data storing section for storing at least game result data for each of the players operating the second game devices;
a first usable data providing section for providing the second game devices with first usable data that are included in the game result data for each of the players, which are stored in the first data storing section, and that are usable by each of the players when the second game program is executed by the player in the second game device; and
a second usable data providing section for providing the first game devices with second usable data that are included in the game result data for each of the players, which are stored in the second data storing section, and that are usable by each of the players when the first game program is executed by the player in the first game device,
wherein the first game program is configured to allow each of the players operating the first game devices to proceed with the game using the game result data for the player stored in the first data storing section and the second usable data for the player provided by the second usable data providing section; and
wherein the second game program is configured to allow each of the players operating the second game devices to proceed with the game using the game result data for the player stored in the second data storing section and the first usable data for the player provided by the first usable data providing section.

9. The game system according to claim 2, wherein:
the first usable data transmitting section is configured to transmit data updated from the previously transmitted first usable data as the first usable data for each of the players to be next transmitted; and
the second usable data transmitting section is configured to transmit data updated from the previously transmitted second usable data as the second usable data for each of the players to be next transmitted.

10. The game system according to claim 2, further comprising at least one first game server and at least one second game server, wherein:
the first game devices are connected to the at least one first game server and the first game control server stores in the first data storing section at least the game result data for each of the players transmitted from the at least one first game server; and
the second game devices are connected to the at least one second game server and the at least one second game control server stores in the second data storing section at least the game result data for each of the players transmitted from the at least one second game server.
